(19) United States
(12) Patent Application Publication
(10) Pub. No.: US 2002/0092806 A1
(43) Pub. Date: Jul. 18, 2002

(54) Device for the separation of liquid from waste produced by milling or cutting operations

(76) Inventor: Ludwig Kaminski, Triesen (LI)

Correspondence Address: M. Robert Kestenbaum, 11011 Bermuda Dunes NE, Albuquerque, NM, 87111, US

(21) Appl. No.: 10/052,079

(22) Filed: Jan. 16, 2002

(30) Foreign Application Priority Data
Jan. 16, 2001 (CH) 2001 0056/01

(51) Int. Cl. B01D 29/35; B01D 29/64

(52) U.S. Cl. 210/415; 210/416.1

(57) ABSTRACT

A device for separating liquid from waste produced by milling or cutting operations, and particularly from waste arising during the milling of plastics surfaces, comprises a housing for taking up the liquid separated from the waste and a screening device communicating with this housing. The liquid containing the waste is introduced through a means for introduction into the screening device. Means for a continuous recovery of the waste are associated with the screening device, where the waste is continuously conveyed toward a recovery means associated with the screening device. The screening device and, where applicable, the housing are of cylindrical shape. The means for continuous recovery are provided as eccentrically mounted rotary-slide arrangement.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention concerns a device for separating liquid from waste produced by cutting or milling operations, particularly waste arising in the milling treatment of plastics surfaces.

1. Technical Field

Such devices are employed for instance when processing lenses of plastic glasses. Both the glasses and the tools must be cooled when milling, for instance, glasses consisting of polycarbonate, CR 39, or more highly refracting plastics with CNC machines. This is usually done with water conditioned with added polishing oil and stabilizers and cooled to a desired temperature.

The milling is performed with milling heads fitted with polycrystalline diamond tips. They are washed by the cooling liquid with an appropriate, high intensity in order to prevent damage to these tips by the material removed.

Milling operations produce coarser millings as well as very minute and suspended particles. They are each eliminated in a different way.

The cooling liquid is pumped around in a closed circuit in which it is subjected in general to at least two cleaning operations. The suspended particles are filtered off or separated by centrifuging.

The resulting coarser waste such as millings would obstruct the circuit since they clog the pipes or block filters or centrifuges as time goes on. Therefore, it is the custom to mount a screen to the drain pipe of the CNC machine, which catches the millings and must be emptied regularly. This is quite a laborious operation, since the screen containing the millings must be cleaned by hand at intervals depending on the machining operations. Generally, this gives rise to a lower production capacity and higher cost.

### SUMMARY OF THE INVENTION

It has been the aim of the invention, in view of this situation, to provide a device that can be used to perform the manual emptying operation described above in an automated way.

This is achieved by a device for separating liquid from waste produced by milling or cutting operations, and particularly from waste arising during the milling treatment of plastics surfaces, including a housing, more particularly cylindrical, for taking up the liquid separated from the waste, a screening device, more particularly cylindrical as well, communicating with this housing, a means for introducing the liquid containing the waste into the screening device, said means for a continuous recovery of the waste having the form of an eccentrically mounted rotary slide arrangement are associated with the screening device, where the waste is continuously conveyed toward a recovery means associated with the screening device. Alternative or preferred embodiments are described in the characteristics of the dependent claims.

Since means for a continuous removal of waste are associated with the screening device where waste is continuously conveyed toward a recovery means associated with the screening device, it is not necessary to interrupt the production process, as the screening device is always cleared of the millings or coarser cutting waste.

A rotary slide arrangement mounted eccentrically into the screening device conveys the millings arriving in the screening device toward the recovery means while a certain compression of the waste and thus a more straightforward recovery become possible at the same time. In the recovery means itself, recovery can be realized via a driven screw conveyor, or a suction pump can be associated with the recovery means to drain off the waste; the waste can also be compressed with a piston.

### BRIEF DESCRIPTION OF THE DRAWINGS

In the following, the device will be described purely as an example while referring to the drawings in which

FIG. 1 shows a device according to the invention with means for the continuous recovery of waste realized as a rotary slide; and

FIG. 2 shows a variant of an embodiment of the device according to the invention having a screen arranged in the wall of the housing.

### DETAILED DESCRIPTION OF THE INVENTION

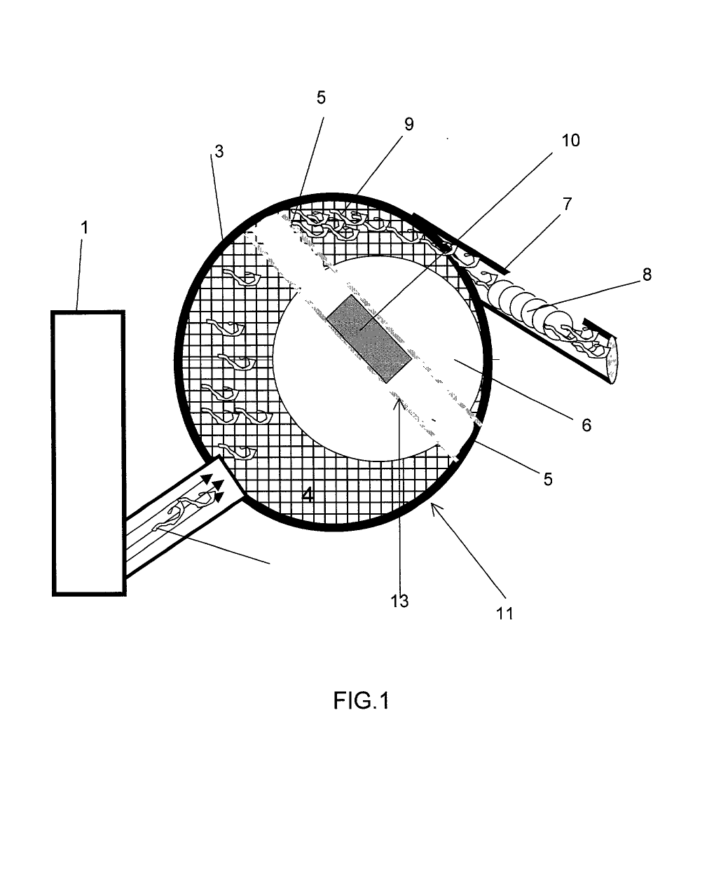

FIG. 1 represents in section a device according to the invention having a cylindrical screening device 3 arranged in a housing 11 that also is cylindrical. The screening device 3 unfolds a screen 4 of medium mesh size at its lower boundary. In the working of PC and more highly refracting plastics for the manufacture of glasses, for instance, a mesh size of about 1 mm is the rule.

The production of the plastic parts occurs in a CNC machine tool 1, the cooling liquid charged with waste 9 is brought to the screening device 3 through a means of introduction 2, the liquid passes the screen 4, while the coarser waste 9 such as millings are retained by the screen.

A cylinder 6 of smaller diameter having plane parallel guide slots 12 is arranged eccentrically within the screening device 3. The cylinder is arranged in such a way that in one zone the distance between cylinder 6 and the inner wall of the screening device 3 is as small as possible.

Two slides 5 slide within the guide slots 12 of cylinder 6 and are pressed against the inner wall of the screening device 3 by a spring means 10. They rest on screen 4 with their bottom edge. The material of the slides 5 or at least of their bottom edge is so selected that seizing on screen 4 is avoided as far as possible. Thus, plastic or a Teflon coating can be provided. The bottom edges can also be fitted with a brush or drag attachment.

Close to the zone of smallest distance between cylinder 6 and the inner wall of the screening device 3, a recovery pipe 7 branches off tangentially.

Cylinder 6 is made to rotate, so that slides 5 take the waste 9 along with them and push it into the smaller space in front of the recovery pipe 7. From there the waste is eliminated to the outside through recovery pipe 7.

It is possible to provide a screw conveyor 8 within the recovery pipe 7 which will support the recovery or reduce the volume of the millings, by pushing the millings through a tapering pipe in order to keep the volume of waste as small as possible. As an alternative, the millings can also be eliminated by a suction pump (not shown) associated with the recovery pipe 7, or compressed with a piston.

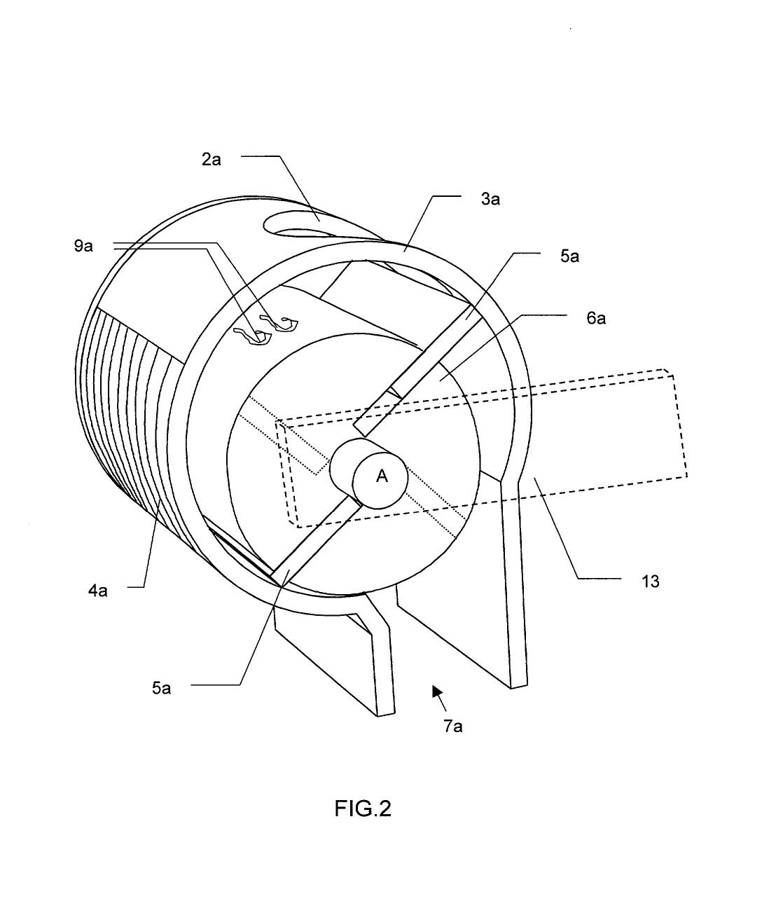

A variant is shown in FIG. 2. Here the axes of the cylindrical housing 3a and the eccentrically arranged cylinder 6a are essentially oriented horizontally when in their working position. A front cover of the housing closes the housing 3a off tightly when in its working position, but can be taken off in order to remove residual millings and to clean the housing. The axle A of cylinder 6a is preferably mounted in an elastic way, for instance with a bearing 13 (shown in dashed lines). Should the millings 9a agglomerate and become seized in the zone of the slotted screen or recovery means 7a, then cylinder 6a can adapt to this situation to a certain extent. The means 2a for introducing the liquid is arranged at the top of the housing when in its working position. By rotation of cylinder 6a—here counter clockwise—the liquid containing the millings is conveyed toward a slotted screen 4a, which has the same radius of curvature as the cylindrical housing and is arranged in this housing. The slots of this slotted screen 4a can have a width of 0.1 to 1 mm, and generally will be arranged so as to run perpendicularly to the axle of cylinder 6a, but they can also be arranged obliquely or parallel to this axle. The liquid escapes through the slotted screen 4a while the millings are compressed and conveyed almost free of moisture to the recovery means 7a. Here, too, they could be conveyed further with a screw or piston. Instead of two slides 5a, a plurality of slides could be provided, for instance four slides as schematically shown in FIG. 2. For improved sliding, the slides and/or the inner wall of the housing can be made of plastic or coated with Teflon.

I claim:

1. A device for separating liquid from waste produced by milling or cutting operations, and particularly from waste arising during the milling treatment of plastics surfaces, comprising a housing, more particularly cylindrical, for taking up the liquid separated from the waste, a screening device, more particularly cylindrical as well, communicating with this housing, a means for introducing the liquid containing the waste into the screening device, said means for a continuous recovery of the waste having the form of an eccentrically mounted rotary slide arrangement are associated with the screening device, where the waste is continuously conveyed toward a recovery means associated with the screening device.

2. The device according to claim 1, wherein said recovery means is hinged—preferably tangentially—to the screening device in the compression zone of the rotary slide arrangement.

3. The device according to claim 1, wherein said recovery means is of tubular shape and presents a screw conveyor.

4. The device according to claim 1, wherein said recovery means comprises a suction pump.

5. The device according to claim 1, wherein said screening device has a screen, more particularly a slotted screen, associated with the inner wall of the housing.

6. The device according to claim 1, wherein the axle of the rotary slide arrangement is elastically mounted.

7. The device according to claim 1, wherein the slides of said rotary slide arrangement and/or the inner wall of said cylindrical housing consist of plastic or are coated with Teflon.
